(19) United States
(12) Patent Application Publication
(10) Pub. No.: US 2018/0182359 A1
(43) Pub. Date: Jun. 28, 2018

(54) REDUCING POWER CONSUMPTION OF MOBILE DEVICES THROUGH DYNAMIC RESOLUTION SCALING

(71) Applicant: MICROSOFT TECHNOLOGY LICENSING, LLC, Redmond, WA (US)

(72) Inventors: Yunxin LIU, Redmond, WA (US); Hucheng ZHOU, Redmond, WA (US)

(73) Assignee: MICROSOFT TECHNOLOGY LICENSING, LLC, Redmond, WA (US)

(21) Appl. No.: 15/739,127

(22) PCT Filed: Jun. 24, 2016
(86) PCT No.: PCT/US2016/039133

§ 371 Date: Dec. 21, 2017

(30) Foreign Application Priority Data
Jun. 26, 2015 (CN) PCT/CN2015/082450
Jul. 17, 2015 (CN) 201510423290.5

(51) Int. Cl. G09G 5/373; H04W 52/02; G06F 9/54

(52) U.S. Cl. CPC G09G 5/373; H04W 52/027; G09G 2360/08; G09G 2340/0407; G09G 2354/00; G06F 9/54

(57) ABSTRACT

A computing device may dynamically adjust a pixel density based at least in part on a viewing distance between a user and a display of the computing device. In some examples, the viewing distance may be determined using low power acoustic (e.g., ultrasonic) sensing. A pixel density at which to display content may be determined using algorithms based on the viewing distance and a visual acuity of a user. Content to be displayed on the computing device may be sent to processors of the computing device for graphics processing. In some examples, the content may be intercepted, such as by using a hooking process, before processing and scaled based on the determined pixel density. Scaling down the pixel density of the content may require less system resources to process the content, which may result in less power consumption by the processors to perform the graphics processing operations.

### BACKGROUND

Computing devices increasingly have high-resolution displays which display content at high display densities. However, these high-resolution displays consume large amounts of system resources, especially processing power, which in turn leads to higher system power consumption. As battery lifetime is critical for computing devices, especially mobile devices, these high resolution displays may result in poor user experience by limiting the amount of time a user may interact with their electronic device before the battery needs to be recharged. Moreover, in many cases such high display density displays present pixels at a size far beyond the visual-perceivability of human eyesight, even when the viewing distance is very short. Thus, presenting content at a display density beyond the visual-perceptibility of a human results in increased power consumption without any increase in user viewing experience.

### SUMMARY

This application describes dynamic resolution scaling (DRS) techniques to reduce the amount of system resources required to process and render graphical content. In the case of battery powered devices, this may in turn result in less power consumption by the system resources to perform the graphics processing operations. Humans have upper limits at which they can visually-perceive display density of pixels. For example, users that are considered to have normal vision (e.g., 20/20 vision) are able to separate contours that are approximately 1.75 mm apart on a display when standing 20 feet away. Human visual acuity generally increases as a human is closer to the object they are viewing, and decreases as the human is further from the object they are viewing. The techniques described in this application dynamically adjust display resolution to reduce system resources to process and render content without sacrificing user experience.

In one example, a computing device may detect a viewing distance between a user of the computing device and a display of the computing device using one or more sensors (e.g., acoustic sensors) of the computing device. The computing device may present content on the display at a resolution having a threshold pixel density based at least in part on the detected viewing distance. For instance, the computing device may present the content at a resolution having a pixel density lower than a maximum display resolution, but at or above a maximum human visual-perceivability at that distance. This may result in decreased processing power required to display the content without reducing a user's viewing experience.

In some examples, the computing device may modify the display resolution locally. Rather than processing the content at the default resolution (e.g., received resolution or stored resolution), the computing device may modify the display resolution before the content is processed by one or more processors. By reducing the display resolution of the content before the graphics processing operations are performed by processors of the computing device, the graphics processing load may be reduced, which may in turn result in decreased power consumption by the computing device.

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicates similar or identical items. Moreover, the figures are intended to illustrate general concepts, and not to indicate required and/or necessary elements.

FIGS. 1A-1B illustrate an example scenario for determining a distance between a user and a display of a computing device and modifying the resolution of content presented on the display.

FIG. 2 illustrates example details of a computing device.

FIG. 3 is a component diagram showing an example configuration for interacting with the graphics processing operations of a computing device to modify the resolution of content to be displayed by the computing device.

FIG. 4 is a flow diagram showing an example method to modify the resolution of content to be displayed by a computing device.

### DETAILED DESCRIPTION

As discussed above, computing devices increasingly have displays which display content at high display resolutions. Displaying content at high pixel display densities requires large amounts of system resources, such as processing power, which in turn leads to high system power consumption. However, many of these high pixel display densities are beyond the visual-perceptibility of humans. Accordingly, many display devices display content at resolutions that require large amounts of processing power, but do not result in improved user experiences than a lower resolution may provide.

This disclosure describes techniques to identify a pixel density at which to display content to a user based at least in part on a distance of the user from the display. For instance, the computing device may present the content at a pixel density lower than a maximum display density of the computing device, but at or above a human visual-perceivability density (i.e., a density above which an average human having 20/20 vision is unable to perceive an improvement in image quality) at that distance. Applying the techniques may limit an amount of system resources required to process and render graphical content without sacrificing user experience. In the case of battery powered devices, this may in turn result in less power consumption by the system resources to perform the graphics processing operations.

In some examples, the techniques described herein may be implemented using sensors of the computing device. For example, the sensors of the computing device may determine how far a user of the device is from a display of the computing device. While examples herein describe causing acoustic sensors (e.g., ultrasonic, sonic, and/or infrasonic sensors), any other sensor usable for measuring distance may be employed (e.g., a camera or thermal sensor). Using acoustic sensors is one example low power technique for measuring the distance between the user and the display of the computing device. For example, an acoustic sensor may comprise a transmitter and receiver and be part of the computing device, or communicatively attached to the computing device. The acoustic sensor may be employed to emit an acoustic signal from the display towards the user. The acoustic sensor may then receive the signal after it has been reflected off the user. By knowing the frequency at which the signal was transmitted, and the amount of time between sending the signal and receiving its reflection, the computing device may calculate the viewing distance at which the user is viewing the display of the computing device.

After calculating the viewing distance of the user, the computing device may determine a pixel density at which to display content on the screen based on the distance. In some examples, the computing device may have components that employ algorithms to calculate a pixel density threshold at which a human is able to visually perceive the pixels.

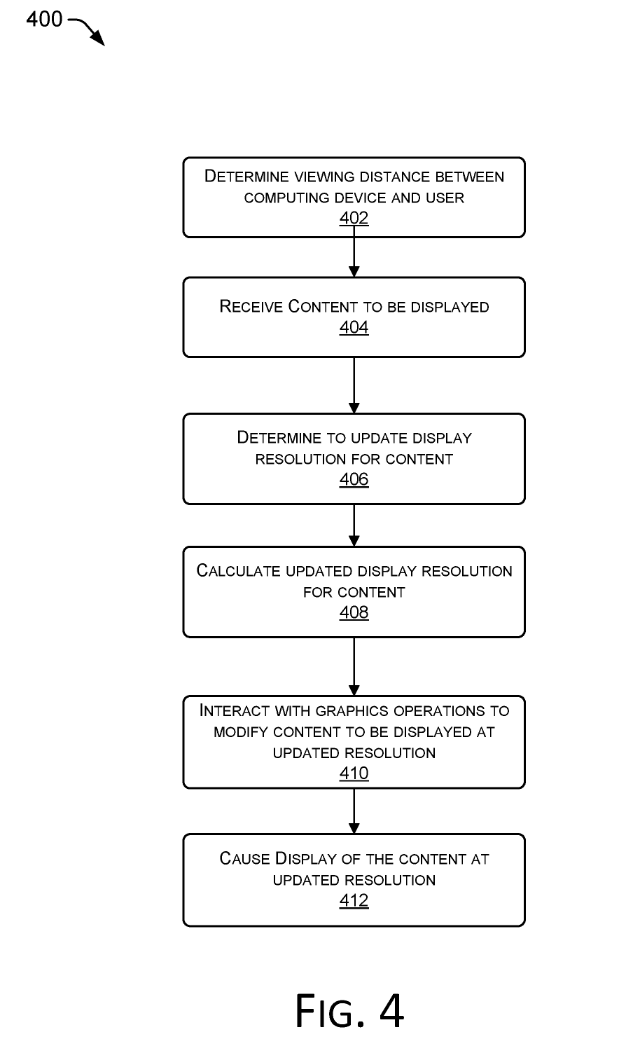

For example, when a user is closer to the display of the computing device, the pixel density may be higher (i.e., smaller pixel size or greater pixel per inch (PPI)) than if the user is further away from the display of the computing device. In some examples, the pixel density calculation may be user specific. For example, the computing device may obtain the visual acuity of a user (e.g., through explicit input via a user interface of the computing device or implicit input by observing the user's viewing distances and habits for viewing various content), and based on the user's specific visual-perceivability, select a pixel density at which to display content. In other examples, the computing device may query a lookup table containing various pixel densities and associated viewing distances associated with human visual-perceivability. Based on the determined viewing distance, the lookup table may provide a pixel density at which to display the content. In some examples, the computing device may employ various mathematical functions or formulas to calculate a pixel density based on the determined viewing distance. The calculations may be employed in real-time, or near real time. Details of the mathematical formulas are described in more detail with reference to FIG. 4.

Once a display pixel density has been selected, one or more components of the computing device may interact with graphics processing operations (e.g., graphics pipeline) to modify the pixel density of the content. For example, a provider of the content (e.g., an application such as YouTube® or Bing®) may transmit content to the computing device at a default pixel density (e.g., the default pixel density of the computing device display). In some examples, the content may be stored locally on the memory of the computing device. For example, an application may access content stored in the memory, such as a media player application that accesses video and/or audio media loaded and stored on memory of the computing device. Similarly, the application may display content on a display of the computing device at a default pixel density. The components may intercept a call, sent from an application that is providing the content, to an API that manages the processors (e.g., Central Processing Unit (CPU), Graphical Processing Unit (GPU), etc.), in order to modify the default pixel density. Upon intercepting the call from the application, the components may apply a scaling factor to parameters of the call, such as the default pixel density. By scaling the default pixel density down before processing the content at the processors, this may reduce the processor load by reducing the number of pixels that need to be processed under the graphics pipeline operations. For instance, by reducing the pixel density, the number of pixels that need to undergo graphics processing operations (e.g., rendering) may be decreased, which may in turn reduce the time and power required by the processors. This may in turn reduce the power requirements of the processor(s) to process the content for display.

In the examples discussed above, and in many of the examples below, the techniques are described using components that are software components. By using software components to implement techniques described herein, it may allow for implementation of the invention without requiring changes to the hardware, middleware, operating system, and/or applications of the computing device. However, the techniques may be applied using hardware components in other examples.

The techniques described herein may be implemented in whole or in part by one or more system resources located on the computing device. As used herein, system resources refer to physical hardware resources of the computing device, such as processors (e.g., CPU, GPU, etc.), memory (e.g., RAM, ROM, etc.), and the like.

In some embodiments, the techniques may reduce processing load for the computing device by reducing the pixel density of the content to be displayed. This reduction in processing load may result in less system power requirements, which may result in longer battery lifetime. Additionally, the reduction in processing load may also reduce the amount of heat created and emitted from the hardware components involved in the processing, which may also increase the battery lifetime. In some embodiments, battery lifetime may be increased without compromising user experience. In some examples, the techniques may take into account an individual user's visual acuity.

This brief introduction is provided for convenience and illustration. This introduction is not meant to limit the scope of the claims, nor the proceeding sections. Furthermore, the techniques described in detail below may be implemented in a number of ways and in a number of contexts. Example implementations and contexts are provided with reference to the following figures, as describe below in more detail. It is to be appreciated, however, that the following implementations and contexts are only examples of many.

### Example Scenario

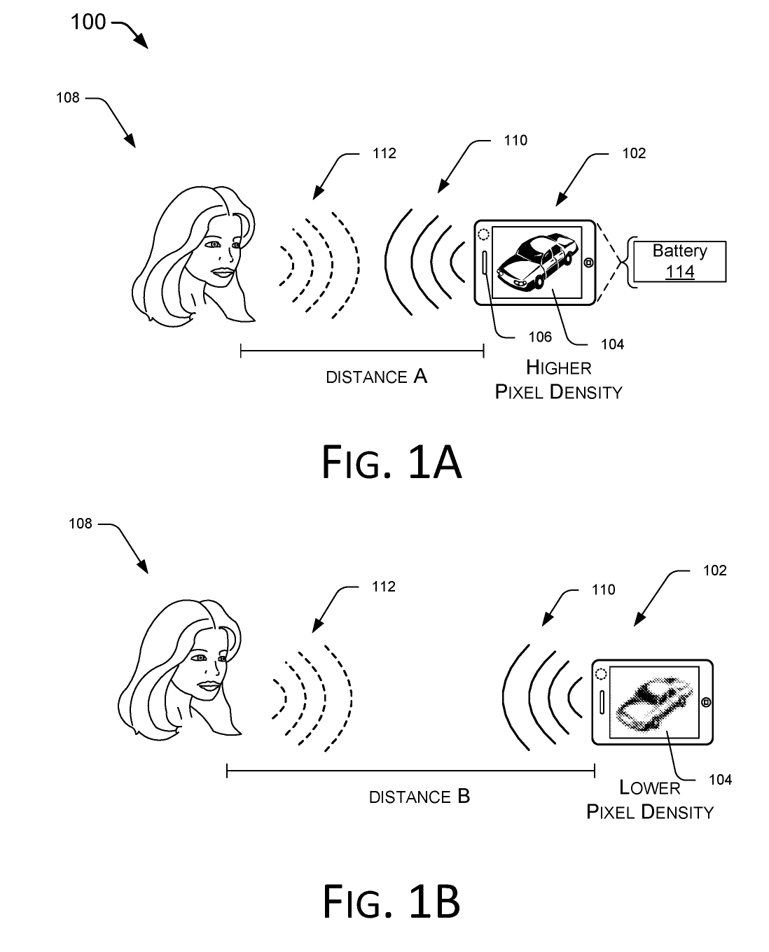

FIG. 1 illustrates an example scenario for determining a distance between a user and a display of a computing device, and modifying the pixel density of content presented on the display. Example scenario 100 includes two different illustrations of the techniques described herein, FIGS. 1A and 1B. As shown in FIG. A, computing device(s) 102 may include a display(s) 104 for displaying content, an automobile in this example.

Computing device(s) 102 may be implemented as any type of computing device including, but not limited to, a laptop computer, a tablet, a smart phone, a desktop computer, a game console, an electronic reader device, a portable media player, a mobile handset, a personal digital assistant (PDA), a computer monitor or display, a set-top box, a computer system in a vehicle, a handheld gaming device, a smart television (TV), a smart watch, and so forth. In some instances, computing device(s) 102 may comprise a mobile device at least a portion of which is movable relative to a user, while in other instances the device may be stationary and the user may be movable relative to the device or a portion thereof.

The computing device(s) 102 may have sensor(s) 106 for measuring a distance between the display(s) 104 of the computing device(s) 102 and a user 108. In some examples, sensor(s) 106 may be built into the computing device(s) 102, such as a camera, a microphone and receiver (e.g., for hearing and speaking into a phone), acoustic sensors, thermal sensors, or any other appropriate sensor for measuring distance. In other examples, sensor(s) 106 may be detachable sensor(s) that users are able to communicatively connect and removeably attach to the computing device.

As shown in the example scenario of FIG. 1A, sensor(s) 106 may comprise an acoustic sensor, including a transmitter and receiver. The transmitter may emit signal(s) 110 at a predetermined frequency. In some instances, the frequency may be transmitted at one or more frequencies above human hearing range (e.g., at least about 20 KHz or higher), below the human hearing range (e.g., at most about 20 Hz or lower), or within human hearing range (e.g. between about 20 Hz to 20 KHz). Sensor(s) 106 may be positioned to face in a same direction as display(s) 104 in order to emit signal(s) 110 in the direction of the user 108. After sensor(s) 106 emit signal(s) 110 towards the user 108, at least a portion of signal(s) 110 may be reflected off user 108 and bounce back towards sensor(s) 106, which collects reflected signal(s) 112. Computing device(s) 102 may determine an amount of time between when sensor(s) 106 emit signal(s) 110 and when sensor(s) 106 receive the reflected signal(s) 112. Based on the determined amount of time and the predetermined frequency, computing device(s) 102 may calculate a distance A between user 108 and display(s) 104. As described in further detail below, computing device(s) 102 may determine a pixel density at which to display the content on display(s) 104 based on the visual acuity of a human and the calculated distance A.

Computing device(s) 102 may contain a battery 114 which may be utilized to power computing device(s) 102. Additionally or alternatively, computing device(s) 102 may be connected to an AC power source (e.g., power grid). Battery 114 may include multiple batteries, or a single battery. In some instances, battery 114 may be contained in the interior of computing device(s) 102, or the exterior of computing device(s) 102. Additionally, in some instances sensor(s) 106 may include their own battery, or be powered by battery 114 of computing device(s) 102.

In some examples, as shown in FIG. 1B, the content may be displayed at a lower pixel density when the user 108 is a distance B away from the computing device, and distance B is further than distance A.

### Example Computing Device

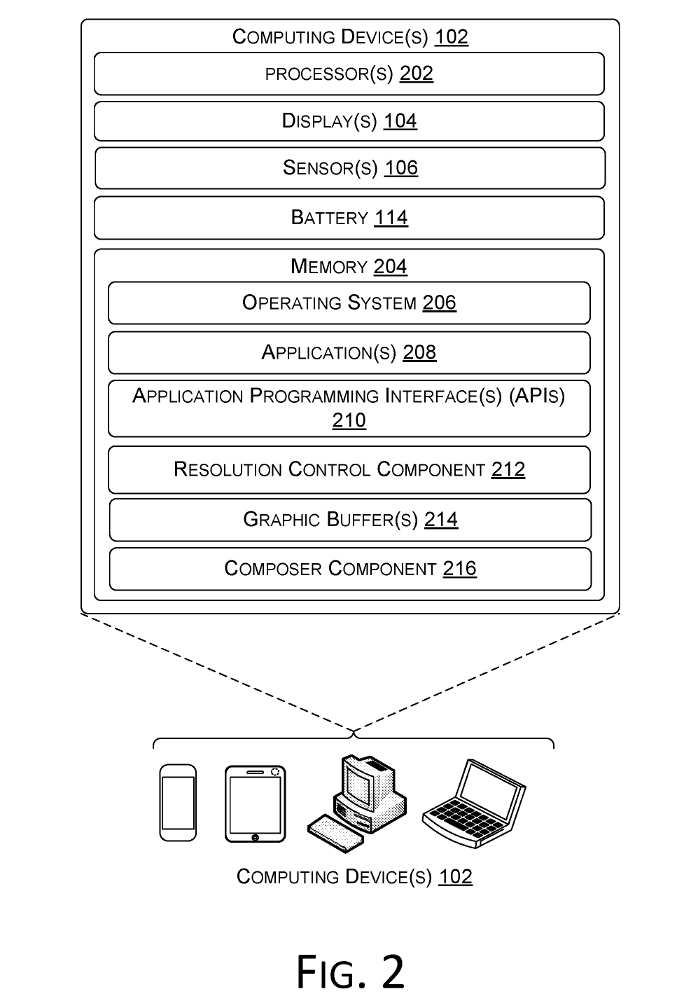

FIG. 2 illustrates example details of a computing device, such as computing device(s) 102 as depicted in the example scenario 100, configured to modify pixel densities for content. Computing device(s) 102 may include processor(s) 202, display(s) 106, sensor(s) 106, and memory 204 communicatively coupled to processor(s) 202. Processor(s) 202 may include a central processing unit (CPU), graphics processing unit (GPU), microprocessor, and so on. Computing device(s) 102 may further include additional elements, such as a microphone, touch screen, wireless network sensor, accelerometer, compass, gyroscope, Global Positioning System (GPS), or other elements. Sensor(s) 106 may include a camera, motion sensor, an acoustic sensor, an electromagnetic sensor, a thermal sensor, or any other sensor suitable for determining a distance between display(s) 104 and user 108.

As illustrated, memory 204 may include an operating system (OS) 206 which may manage resources of computing device(s) 102 and/or provide functionality to application(s) 208. Application(s) 208 may be various applications, such as a web browser, mobile application, desktop application, or any other application. In one example, application(s) 208 may be a music library application that displays media for user 108 to select. In another example, application(s) 208 may be a video streaming application which communicates with server that provides video content over one or more networks. In other examples, application(s) 208 may be a media player for playing local media, or media stored on computing device(s) 102. The one or more networks may include any one of or a combination of multiple different types of networks, such as cellular networks, wireless networks, Local Area Networks (LANs), Wide Area Networks (WANs), Personal Area Networks (PANs), and the Internet.

In some embodiments, application(s) 208 may be stored on memory 204 of computing device(s) 102. After receiving content to be displayed, application(s) 208 may call (i.e., send a request to) application programming interface(s) (APIs) 210 to facilitate the processing of content to be displayed. For example, APIs 210 may be a set of predefined commands or functions that are callable by application(s) 208 to cause performance of their associated functions. In some examples, APIs 210 may be organized in a library (e.g., DirectX® and OpenGL® ES) that is callable by application(s) 208.

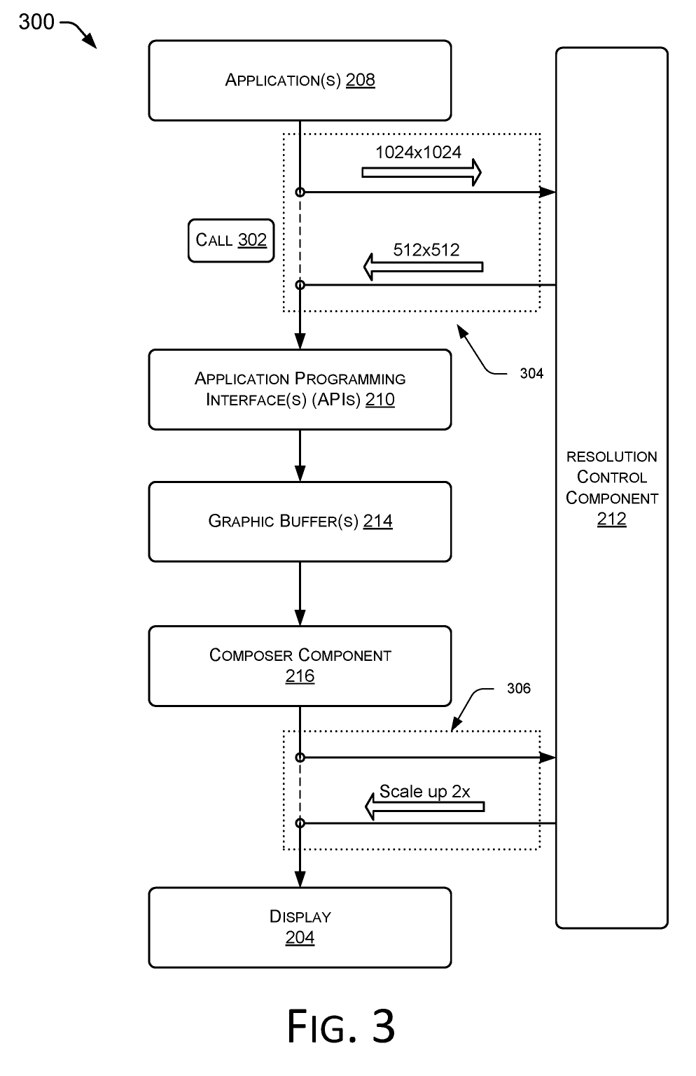

APIs 210 may comprise a single API, or multiple APIs, where each of the APIs 210 may be called to perform one or more functions. Application(s) 208 may call API(s) 210, whose functions are stored in a library (e.g., Open Graphics Library for Embedded Systems (OpenGL® ES)). In some examples, application(s) 208 may call APIs 210 whose functions are to employ processor(s) 202 to perform graphics processing on the content to prepare the content for display. For example, APIs 210 may comprise a function that uses processor(s) 202 to perform graphics pipeline operations, which will be discussed in further detail below with respect to FIG. 3. In some examples, processor(s) 202 that perform the graphics pipeline operations may be a GPU, a CPU, or a combination of both.

In some examples, resolution control component 212 may interact with the graphics processing operations (e.g., graphics pipeline operations) to modify a display resolution of content to be displayed on display(s) 104. The content may be provided by application(s) 208 in some examples. For example, the resolution control component may intercept the call from application(s) 208 and before the call reaches APIs 210. The call may indicate one or more parameters indicating how to render the content. In some instances, the one or more parameters may indicate a default pixel density at which to display the content, and may also indicate a default size to display the content on display(s) 104. The default pixel density may be determined by the content provider (e.g., application(s) 208), or the default pixel density may be determined based on one or more pixel densities at which display(s) 104 are capable of displaying content. In other examples, the default pixel density may be determined based on the default pixel density of display(s) 104. Before the call is received by APIs 210, resolution control component 212 may intercept the call sent by application(s) 208. Resolution control component 212 may apply one or more scaling factors to the one or more parameters of the call. For example, resolution control component 212 may apply a scaling factor to the one or more parameters to cause the content to be processed and displayed at a different pixel density (e.g., modified or calculated pixel density) than the default pixel density.

In some instances, the pixel density may be determined based on the viewing distance at which user 108 is viewing display(s) 104. The pixel density may additionally or alternatively be determined based on a predetermined visual acuity of a human. The predetermined visual acuity may be user-specific, or be based on an average human eyesight (e.g., normal or 20/20). In some examples, resolution control component 212 may provide a graphical user interface (GUI) by which user 108 may enter their eyesight. Based on the user's eyesight, resolution control component 212 may calculate an updated pixel density at which to display the content at. In some instances, this may provide a better user viewing experience, and may further reduce power consumption for computing device(s) 102. For example, users who have poor eyesight (e.g., worse than 20/20) may have a lower visual-perceptibility at which they can detect pixels for different distances. Thus, for those users, resolution control component 212 may determine a lower pixel density (e.g., larger pixel sizes) to display the content at for a viewing distance than a pixel density used for a user 108 with normal, or average vision. Thus, based on the visual acuity of user 108, or a predetermined visual acuity value (e.g., “normal” or 20/20), resolution control component 212 may determine a pixel density at which to display the content on display(s) 104. In some examples, resolution control component 212 may query a lookup table populated with viewing distances that are each associated with a one or more pixel density. Additionally or alternatively, resolution control component 212 may employ algorithms to calculate a pixel density at which to display the content, details of which will be discussed below with respect to FIG. 3.

Resolution control component 212 may be implemented as hardware, or as software, or a combination of both. In some instances, resolution control component 212 may be implemented as part of the operating system, while in other instances, resolution control component 212 may be downloadable software that interfaces with the operating system (e.g., a “patch”). Additionally, in some instances it may be advantageous to implement resolution control component 212 as a software component. For example, by implementing resolution control component 212 as a downloadable software component (e.g., a patch), no changes to the hardware, operating system 206, or application(s) 208 may be required. Thus, resolution control component 212 may be implemented on computing device(s) 102 to interface with APIs 210, operating system 206, and/or application(s) 208 on a system level in such a way as to be usable with any application(s) 208. Rather than interacting with application(s) 208, resolution control component 212 may interact at a system level with system functions, via APIs 210, in such a way that the content resolution may be changed without requiring any changes to application(s) 208.

Once resolution control component 212 has calculated a pixel density at which to display the content, and applied a scaling factor to the one or more parameters based on the calculated pixel density, resolution control component 212 may send the call to APIs 210 to facilitate graphics processing, by processor(s) 202, of the content at the calculated pixel density. By causing processor(s) 202 to perform graphics processing operations at the calculated pixel density, this may result in less data for processor(s) 202 to process for display, which may result in less power consumption required. The graphics processing operations will be described in further detail below with respect to FIG. 3.

Once processor(s) 202 have completed the graphics processing on the content at the calculated pixel density, the processing result may be stored in graphic buffer(s) 214. In some instances, graphic buffer(s) may comprise a single graphics buffer, or multiple graphics buffers. For example, each application(s) 208 may be assigned its own graphic buffer(s) 214 for storing content that has been processed by processor(s) 202. After storing the processing result, or the processed content, in graphic buffer(s) 214, composer component 216 may coordinate all the graphics layers from application(s) 208.

Additionally, composer component 216 may composite all visible graphics layers together. Once composer component 216 has composited all visible layers together, composer component 216 may generate the final graphics data into graphic buffer(s) 214. Graphic buffer(s) 214 may comprise any type of data buffer, such as a system data buffer (e.g., framebuffer).

While composer component 216 may be a single software component, it may also be implemented in several different components, such as a system surface and a hardware composer. For example, composer component 216 may include a system service (e.g., surfaceflinger) to coordinate all the graphics layers from the running application(s) 208. The system service may collect all the graphic buffer(s) 216 for visible layers and request a separate component (e.g., hardware composer) to composite all the visible layers together. In some instances the hardware composer may perform the composition and load the final graphics data into the system, while in other instances the hardware composer may request the system service (e.g., surfaceflinger) to call APIs 210 to use the processor(s) 202 for buffer composition. Upon completing the composition, the final graphics data may be loaded into graphic buffer(s) 216 (e.g., framebuffer) for displaying on display(s) 104.

### Example Techniques

FIG. 3 shows a component diagram 300 of an example configuration for interacting with the graphics processing operations of a computing device to modify the resolution of content to be displayed by display(s) 104 of computing device(s) 102. As described above, application(s) 212 may send a call 302 (e.g., request) to APIs 210. Generally, call 302 comprises one or more function calls indicating what application(s) 208 are requesting from APIs 210. For example, call 302 may comprise one or more functions requesting graphics rendering to be performed on content provided by application(s) 210 to be displayed at display(s) 104. In the case of call 302 comprising functions requesting graphics rendering, call 302 may include one or more parameters that indicate a default rendering target for resolution scaling. In the traditional instance, call 302 would proceed to APIs 210, which would in turn cause processor(s) 202 to perform graphics operations on the content to be rendered. However, in one example, resolution control component 212 may insert an upper layer 304 to intercept call 302 before it reaches APIs 210. Upper layer 304 may intercept call 302 using a form of API hooking. For instance, upper layer 304 may examine call 302 sent from application(s) 208 to determine the function of APIs 210 being called. If upper layer 304 determines that call 302 is requesting APIs 210 to render content for display, then resolution control component 212 may cause upper layer 304 to intercept call 302 before it reaches APIs 210.

After call 302 is intercepted, resolution control component 212 may applying a scaling factor to one or more parameters of call 302. For example, assume that a default pixel density for computing device(s) 102 is 1024×1024 pixels, and that the calculated pixel density at which to display the content on display(s) 104 is 512×512 pixels. In this instance, resolution control component 212 may apply a scaling factor of 0.5 to scale down the pixel density by 2×. By applying the scaling factor to the function of call 302, the one or more parameters of the function call 302 may be scaled down to display the content at 512×512 pixels. Thus, by intercepting call 302 before reaching APIs 210, the pixel density at which the content is to be displayed may be processed by processor(s) 202 at a lower pixel density which may reduce the processor load and may result in lower system power requirements, thereby extending battery lifetime of computing device(s) 102.

Once resolution component 216 has applied the calculated scaling factor, details of which will be described in further detail with reference to FIG. 4, the call 302 may be sent to APIs 210 which facilitate graphics processing of the content. The graphics processing may be performed by the CPU, GPU, or any other processor(s) 202 contained in computing device(s) 102. APIs 210 may store the content in graphic buffer(s) 214 and cause processor(s) 202 to perform graphics processing on the content at the calculated pixel density.

Generally, graphics processing consists of a sequence of operations called a graphics pipeline. While a modern graphics pipeline may consist of more than ten stages, or operations, the operations may be grouped into three high-level operations: vertex processing, rasterization, and pixel processing. Vertex processing generally comprises processing vertices of geometric scenes and relationships. The vertices may be processed by performing operations such as transformations and skinning. Once the vertex processing operation is complete, the rasterization operation solves relationships among the vertexes and maps the lines and triangles formed by the vertexes to a window-pixel space. Finally, the pixel-processing operation generates data for each pixel, such as colors and depths for each pixel. This is also done in the window-coordinate space.

In some instances, each of the operations may have their own call 302 and associated functions. The vertex processing operation and pixel processing operation may have functions defined using shader programs, where the source code can be compiled and linked at runtime through API call 302. Thus, because each of the graphics processing operations may have their own call 302, upper layer 304 may intercept multiple calls 302 from application(s) 208 in order to perform the scaling operations on the one or more parameters of the content to be rendered for display.

Once the graphics processing operations are complete, the processed content may be stored in graphic buffer(s) 214 (e.g., buffer queue). In some instances, graphic buffer(s) 214 may comprise a single buffer, or multiple buffers. After storing the processed content in graphic buffer(s) 214, composer component 216 may coordinate all the graphics layers from the running application(s) 208. In some examples, composer component 216 may collect all graphics buffer(s) 214 based on a frame period. For example, display(s) 104 may have a predefined refresh rate (e.g., 60 fps) for each frame period. Based on that predefined refresh rate, composer component 216 may collect all of graphic buffer(s) 214 for each frame period. In some examples, composer component 216 may include a system service (e.g., surfaceflinger) that performs the collection of graphic buffer(s) 214 for each frame period. Once graphic buffer(s) 214 containing the content are collected, composer component 216 may composite all visible layers together. In some examples, composer component 216 may include a hardware composer, a software composer, or both, which perform the composition of the visible layers and generate the final graphics data into graphic buffer(s) 214. In some examples, composer component 216 may use processor(s) 202 to perform buffer composition.

Resolution control component 212 may further insert a lower layer 306 in some instances to intercept call 302 to ensure that the composition is done with the calculated pixel density. Lower layer 306 may be inserted after composer component 216 has composed all of the visible layers. In other instances, lower layer 306 may be inserted between different components of composer component 216. For example, as described above, composer component 216 may include a system service to coordinate all the graphics layers, and a hardware composer to perform the composition and load the final graphics data into the system. In this example, resolution control component 212 may coordinate between upper layer 304 and lower layer 306 to ensure that the composition is done with a proper pixel density. This may be necessary in some instances where the pixel density has been changed using a scaling factor by upper layer 304. For example, call 302 may be intercepted by lower layer 306 to allow resolution control component 212 to scale up the reduced pixel block to the original size (e.g., before the scaling factor was applied) so that it may be displayed on display(s) 104 at the correct size. Thus, resolution control component 212 may coordinate upper layer 304 with lower layer 306 using a synchronization scheme to ensure the content is displayed at the correct size, or original size, before the scaling factor was applied by upper layer 304.

Once the synchronization scheme has been applied by resolution control component 212 using upper layer 304 and lower layer 306, the content may be loaded into graphic buffer(s) 214 (e.g., framebuffer) for display on display(s) 104.

In some embodiments, the interaction performed by resolution control component 212 may be performed at computing device(s) 102, or remote from computing device(s) 102 (e.g., at the server providing the content). However, in some instance it may be advantageous to interact with graphic processing steps performed at computing device(s) 102. For example, rather than having to send a request to a server of application(s) 208 that is providing the content to change the pixel density of the content, the changes to the pixel density of the content may be applied at computing device(s) 102. Performing the scaling operations to the content's pixel density at computing device(s) 102 may have various advantages over performing the operations at a server providing the content. For example, additional time may be required to send the request to and from the server of application(s) 208. Thus, by reducing the amount of time required to update the content, performing the scaling operations at computing device(s) 102 may reduce latency issues, and thus may increase the user viewing experience.

### Example Methods

FIG. 4 is a flow diagram showing an example method to modify the pixel density of content to be displayed by a computing device. At operation 402, a viewing distance between a computing device and a user of the computing device may be determined. As described above, this may be accomplished using sensor(s) 106. In some examples, sensor(s) 106 may comprise an acoustic sensor, thermal sensor, camera, or any other sensor usable to measure a distance between a user and the computing device. For example, sensor(s) 106 may comprise an acoustic sensor. An acoustic sensor may include one or more transmitters and receivers. To measure a distance between user 108 and computing device(s) 102, the transmitters of the acoustic sensor may emit (e.g., transmit) signal(s) 110 from computing device(s) 102 towards user 108. Acoustic signal(s) 110 may be transmitted at a predefined frequency, which may be undetectable by user 108 (e.g., at a frequency beyond hearing range of humans). By transmitting signal(s) 110 towards user 108, at least a portion of signal(s) 110 may be reflected off user 108 back towards sensor(s) 106. This reflected signal(s) 112 may be received by a receiver of acoustic sensor(s) 106.

Based on the amount of time between transmitting signal(s) 110 and receiving reflected signal(s) 112, a distance between computing device(s) 102 and user 108 may be calculated. For example, by knowing the predefined frequency at which signal(s) 110 was transmitted, the relationship between time and frequency (e.g., frequency is the inverse of time) and the amount of time between transmitting signal(s) 110 and receiving reflected signal(s) 112, a distance can be calculated. In some examples, there may be slight error between the measure distance and actual distance. In examples such as these, operation 402 may apply a conservative approach to determining the distance by ensuring that the measured distance is never larger than the real distance. This may result in increased user experience to ensure that the pixel density is always at a density just beyond that of human visual perceivability.

At operation 404, content may be received to be displayed on display(s) 104. In some instances, the content may be received from application(s) 208 (e.g., from a server of application(s) 208) to be displayed on display(s) 104. The content may comprises any content that is capable of being displayed on display(s) 104 of computing device(s) 102 (e.g., text or video). Application(s) 208 may comprise any type of application used by user 108 on computing device(s) 102. (e.g., web browser, video player, music library, email application).

At operation 406, it may be determined whether to update display pixel density for the received content. For example, it may be determined that, based on the viewing distance between user 108 and computing device(s) 102 and the visual acuity of a normal user 108 (e.g., average eyesight or 20/20), the default pixel density may display the content at a pixel density beyond that of which a human can visually perceive. In other words, the default pixel density of the content may be well beyond the pixel density at which the user 108 can actually observe. In other instances, user 108 may have indicated a pixel density at which to display certain content. For example, video content may be displayed at a higher pixel density, whereas text content may be displayed at a lower pixel density. Additionally, it may be determined to display the content at a different pixel density based on the amount of battery power left. For example, if battery power of computing device(s) 102 falls below a certain threshold (e.g., 20 percent), it may be determined to display content at a lower pixel density in order to increase battery lifetime for computing device(s) 102.

At operation 408, after determining to update the pixel density for the content, an updated pixel density may be calculated for the received content. For example, the content may be received at a default pixel density, which in some instances corresponds to the resolution of display(s) 104. As noted above, the content pixel density may be updated based on the determined viewing distance between user 108 and computing device(s) 102. Generally, a human adult may be considered to have normal vision when they are able to separate contours that are approximately 1.75 millimeters apart on an object when standing 20 feet away. In order to mathematically connect visional acuity of user 108 and pixel density at which to display the content, angular resolving acuity may be used to define the visual acuity of user 108 at the determined distance. The angular size of an object may be generally described using the equation

$$δ = 2 {tan}^{- 1} ( \frac{d}{2 D} )$$

where d is the actual size of an object (e.g., pixel size), D is the distance between the object (e.g., pixel on the display) and the user 108, and δ is the angular size of the object in radians. Using this equation, normal vision (e.g., 20/20) may be represented with an angular resolving acuity of δₙₒᵣₘₐₗ=2.9×10⁻⁴ radians, and δₒₚₜᵢₘₐₗ=1.45×10⁻⁴ radians for better than normal vision (e.g., 20/10). Applying this to a specific display(s) 104, operation 408 may consider the number of pixels at the longer side of display(s) 104 as the resolvable pixel number when the pixel density meets the threshold of user's 108 visual acuity at the determined distance. The resolvable pixel number will vary based on the dimensions of display(s) 104. The relationship between resolvable pixel number, the viewing distance of user 108, and user visual acuity may be approximately described using equation

$$N = \frac{L}{2 D tan \frac{δ}{2}}$$

where N is the resolvable pixel number, L is the length of the longer dimension or side of display(s) 104, D is the determined viewing distance, and δ is the angular resolving acuity of the user. As noted before, δ may be a general, predetermined visual acuity (e.g., 20/20 or 20/10), or may be user-specific. In some instances, user 108 may be prompted to enter their visual acuity into a user interface provided by resolution control component 212. One skilled in the art will also appreciate that the equations used herein are merely illustrative of one way to calculate a pixel density. In other examples, different equations or algorithms may be employed to calculate a pixel density at which to display the content.

At operation 410, interactions with the graphics processing operations of computing device(s) 102 may modify content to be displayed at the calculated pixel density determined in operation 408. For example, one or more components of computing device(s) 102 may intercept call 302 sent from application(s) 208 to APIs 210. Call 302 may be a request for APIs 210 to cause graphics processing operations necessary to display the content to be performed by processor(s) 202. Call 302 may contain one or more parameters indicating a default pixel density at which to display the content. By intercepting call 302 before it reaches APIs 210, a scaling factor may be applied to the one or more parameters in order to modify the default pixel density. For example, a scaling factor may be applied to the one or more parameters to lower, or in some instances raise, the pixel density at which the content is to be displayed to the calculated pixel density of operation 408. By applying the scaling factor to the one or more parameters before call 302 reaches APIs 210, the graphics processing operations may be performed at a lower pixel density than the default pixel density, which may require less system resources such as power resources, to facilitate display of the content. By reducing the power resources required by processor(s) 202 to perform the graphic processing operations, this may extend the battery lifetime of computing device(s) 102 while maintaining or increasing user experience. The results of the graphic processing(s) operations may be stored in graphic buffer(s) 216. Before the processed content is displayed on display(s) 104, the one or more components of computing device(s) 102 may intercept call 302, or the content, to ensure that the content to be displayed at the calculated pixel density will be displayed at a same size as the default size at which the content was to be displayed.

At operation 412, the one or more components of computing device(s) 102 may cause display of the content at the updated, or calculated, pixel density. In some instances, the updated pixel density may be a lower pixel density than the default resolution. Additionally, the updated pixel density may present the content at a pixel density just above a threshold density at which humans can see. Thus, by reducing the pixel density at which the content is to be displayed, while keeping the pixel density above the threshold, the content may be presented at a lower pixel density to reduce processing requirements and extend battery lifetime while providing the same user experience as if the resolution were presented in the default pixel density.

In some examples, one or all of operations 402 through 412 may be repeated at a predefined frequency. For instance, one or all of operations 402 through 412 may be repeated roughly 3 times per second (e.g., 3 Hz). In other examples, each one of operations 402 through 412 may be repeated at different predefined frequencies. For example, operation 402 may be repeated at a frequency of 3 times per second, or 3 Hz, whereas operations 406 through 410 may be performed 1 time per second, or 1 Hz. In some examples, operations 402 through 412 may be performed according to a predefined smoothing algorithm. For example, the smoothing algorithm may designate predefined time periods in order to increase or maintain user experience. If pixel density is changed too frequently, or too infrequently, it may be noticeable by a user and result in reduced user experience. For example, operation 402 may be performed at a frequency of 3 times per second or 3 Hz, whereas operations 406 through 412 may be performed at a frequency of one time per second, or 1 Hz. However, any combination of operations and frequencies of performing the operations may be employed in performing operations 402 through 412.

As used herein, memory may include “computer-readable media.” Computer-readable media includes computer storage media and communication media. Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disc ROM (CD-ROM), digital versatile discs (DVD) or other optical storage, magnetic cassettes, magnetic tape, magnetic disk storage or other magnetic storage devices, or any other medium that can be used to store information for access by a computing device. In contrast, communication media embodies computer-readable instructions, data structures, program modules, or other data that is defined in a modulated data signal, such as in conjunction with a carrier wave. As defined herein, computer storage media does not include communication media.

While certain functions are described herein as being implemented by modules executable by one or more processors and other components, any or all of the modules or other components may be implemented in whole or in part by one or more hardware logic components to execute the described functions. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Further, while various modules are discussed herein, their functionality and/or similar functionality could be arranged differently (e.g., combined into a fewer number of modules, broken into a larger number of modules, etc.).

### EXAMPLES

Example A, a computing device comprising: one or more processors; memory communicatively coupled to the one or more processors; a display communicatively coupled to the one or more processors and configured to display content at a plurality of pixel density; one or more sensors to determine a viewing distance between the display and a user of the computing device; a resolution control component stored in the memory and executable by the one or more processors to: determine, based at least in part on the viewing distance, a pixel density of the plurality of pixel densities at which to display the content on the display; intercept a call from an application providing the content to be sent to an application programming interface (API), the call indicating one or more parameters for rending the content at a first pixel density, the first pixel density including a first display size; apply a scaling factor to the one or more parameters to create one or more scaled parameters to render the content at the pixel density; and send the call to the API, wherein the API causes the one or more processors to perform rasterization and pixel processing on the content based on the one or more scaled parameters; and a composer component to cause display of the content on the display of the computing device at the pixel density.

Example B, the computing device of example A, wherein the one or more sensors comprise one or more acoustic sensors comprising one or more acoustic transmitters and receivers, the one or more acoustic transmitters and receivers being located at the display and facing in a same direction as the display.

Example C, the computing device of example A or B, wherein the one or more sensors determine the viewing distance between the display and a user of the computing device by: sending, by the one or more acoustic transmitters, a signal at a predefined frequency; detecting, by the one or more acoustic receivers, at least a portion of the signal that has been reflected off the user of the computing device; determining a time period between sending the signal and detecting the portion of the signal that has been reflected; and based on the time period and the predefined frequency, determining the viewing distance between the display and the user of the computing device.

Example D, the computing device of any of examples A-C, wherein the signal is sent at a first sampling rate and the detecting is performed at a second sampling rate.

Example E, the computing device of any of examples A-D, wherein the resolution control component determines the pixel density by: employing one or more algorithms to calculate a pixel density at which to display the content based at least in part on a visual acuity value, the viewing distance, and a dimension of the display; or querying a lookup table, stored in the memory and populated with predefined pixel densities, to identify a pixel density at which to display the content, each of the predefined pixel densities being associated with one or more predefined distance measurements, and selecting, from the lookup table, the pixel density associated with the distance measurement.

Example F, the computing device of any of examples A-E, wherein the predetermined visual acuity value is based on at least one of: a user-specific visual acuity received through a user interface provided by the resolution controller; or a visual acuity of approximately 20/20.

Example G, the computing device of any of examples A-F, wherein the resolution component further interacts with the one or more graphics processing operations to modify the content by: intercepting the call being sent from the API to the composer component; and applying a second scaling factor to the one or more scaled parameters to display the content at a same size on the display as the first display size.

Example H, a method comprising: under control of one or more processors: determining a viewing distance between a display of a computing device and a user of the computing device; receiving content to be displayed on the display of the computing device, the content being at a first pixel density; based at least in part on the viewing distance, calculating an updated pixel density for the content; intercepting a call, sent from an application associated with the content to an application programming interface (API) of the computing device, the call comprising a request to render the content, by the one or more processors, on the display and indicating one or more parameters for rendering the content at a first pixel density, the first pixel density including a first display size; applying a scaling factor to the one or more parameters to create one or more scaled parameters to render the content at the updated pixel density; and sending the call to the API, wherein the API causes the one or more processors to perform rendering operations to display the content on the display; and causing display of the content, on the display of the computing device, at the updated pixel density.

Example I, the method of example H, wherein determining a viewing distance between a computing device and a user of the computing device comprises: employing one or more acoustic sensors of the computing device to emit a signal from a location proximate the display towards the user, the signal being transmitted at a first frequency; receiving, at the one or more acoustic sensors, at least a portion of the signal that has been reflected off the user; determining an amount of time between emitting the signal and receiving the at least the portion of the signal that has been reflected off the user; and based at least in part on the amount of time and the first frequency, determining the viewing distance between the computing device and the user.

Example J, the method of example H or I, wherein calculating an updated pixel density for the content comprises calculating a pixel density at which to display the content based at least in part on a visual acuity value, the viewing distance, and a dimension of the display.

Example K, the method of any of examples H-J, wherein the visual acuity value is based on a user-specific visual acuity received through a user interface of the display.

Example L, the method of any of examples H-K, wherein the content is displayed at the updated resolution and at a same size on the display as the first display size.

Example M, the method of any of examples H-L, wherein the one or more acoustic sensors comprise one or more ultrasonic or infrasonic sensors.

Example N, the method of any of examples H-M, wherein the one or more ultrasonic or infrasonic sensors emit a signal above an upper threshold frequency or below a lower threshold frequency.

Example O, the method of any of examples H-N, further comprising applying a second scaling factor to the one or more scaled parameters to display the content at a same size on the display as the first display size.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computing device comprising:
one or more processors;
memory communicatively coupled to the one or more processors;
a display communicatively coupled to the one or more processors and configured to display content at a plurality of pixel density;
one or more sensors to determine a viewing distance between the display and a user of the computing device;
a resolution control component stored in the memory and executable by the one or more processors to:
determine, based at least in part on the viewing distance, a pixel density of the plurality of pixel densities at which to display the content on the display;
intercept a call from an application providing the content to be sent to an application programming interface (API), the call indicating one or more parameters for rending the content at a first pixel density, the first pixel density including a first display size;
apply a scaling factor to the one or more parameters to create one or more scaled parameters to render the content at the pixel density; and
send the call to the API, wherein the API causes the one or more processors to perform rasterization and pixel processing on the content based on the one or more scaled parameters; and
a composer component to cause display of the content on the display of the computing device at the pixel density.

2. The computing device of claim 1, wherein the one or more sensors comprise one or more acoustic sensors comprising one or more acoustic transmitters and receivers, the one or more acoustic transmitters and receivers being located at the display and facing in a same direction as the display.

3. The computing device of claim 2, wherein the one or more sensors determine the viewing distance between the display and a user of the computing device by:
sending, by the one or more acoustic transmitters, a signal at a predefined frequency;
detecting, by the one or more acoustic receivers, at least a portion of the signal that has been reflected off the user of the computing device;
determining a time period between sending the signal and detecting the portion of the signal that has been reflected; and
based on the time period and the predefined frequency, determining the viewing distance between the display and the user of the computing device.

4. The computing device of claim 3, wherein the signal is sent at a first sampling rate and the detecting is performed at a second sampling rate.

5. The computing device of claim 1, wherein the resolution control component determines the pixel density by:
employing one or more algorithms to calculate a pixel density at which to display the content based at least in part on a visual acuity value, the viewing distance, and a dimension of the display; or
querying a lookup table, stored in the memory and populated with predefined pixel densities, to identify a pixel density at which to display the content, each of the predefined pixel densities being associated with one or more predefined distance measurements, and
selecting, from the lookup table, the pixel density associated with the distance measurement.

6. The computing device of claim 5, wherein the predetermined visual acuity value is based on at least one of:
a user-specific visual acuity received through a user interface provided by the resolution controller; or
a visual acuity of approximately 20/20.

7. The computing device of claim 1, wherein the resolution component further interacts with the one or more graphics processing operations to modify the content by:
intercepting the call being sent from the API to the composer component; and
applying a second scaling factor to the one or more scaled parameters to display the content at a same size on the display as the first display size.

8. A method comprising:
under control of one or more processors:
determining a viewing distance between a display of a computing device and a user of the computing device;
receiving content to be displayed on the display of the computing device, the content being at a first pixel density;
based at least in part on the viewing distance, calculating an updated pixel density for the content;
intercepting a call, sent from an application associated with the content to an application programming interface (API) of the computing device, the call comprising a request to render the content, by the one or more processors, on the display and indicating one or more parameters for rendering the content at a first pixel density, the first pixel density including a first display size;
applying a scaling factor to the one or more parameters to create one or more scaled parameters to render the content at the updated pixel density; and
sending the call to the API, wherein the API causes the one or more processors to perform rendering operations to display the content on the display; and
causing display of the content, on the display of the computing device, at the updated pixel density.

9. The method of claim 8, wherein determining a viewing distance between a computing device and a user of the computing device comprises:
employing one or more acoustic sensors of the computing device to emit a signal from a location proximate the display towards the user, the signal being transmitted at a first frequency;
receiving, at the one or more acoustic sensors, at least a portion of the signal that has been reflected off the user;
determining an amount of time between emitting the signal and receiving the at least the portion of the signal that has been reflected off the user; and
based at least in part on the amount of time and the first frequency, determining the viewing distance between the computing device and the user.

10. The method of claim 8, wherein calculating an updated pixel density for the content comprises calculating a pixel density at which to display the content based at least in part on a visual acuity value, the viewing distance, and a dimension of the display.

11. The method of claim 10, wherein the visual acuity value is based on a user-specific visual acuity received through a user interface of the display.

12. The method of claim 10, wherein the content is displayed at the updated resolution and at a same size on the display as the first display size.

13. The method of claim 9, wherein the one or more acoustic sensors comprise one or more ultrasonic or infrasonic sensors.

14. The method of claim 13, wherein the one or more ultrasonic or infrasonic sensors emit a signal above an upper threshold frequency or below a lower threshold frequency.

15. The method of claim 8, further comprising applying a second scaling factor to the one or more scaled parameters to display the content at a same size on the display as the first display size.
